(19) United States
(12) Patent Application Publication
(10) Pub. No.: US 2026/0093003 A1
(43) Pub. Date: Apr. 2, 2026

(54) Method and electronic device for determining radio navigation beacons for an aircraft, associated computer program, navigation method, and electronic navigation system

(71) Applicant: THALES, Meudon (FR)

(72) Inventors: Jean-Pierre ARETHENS, VALENCE (FR); Denis BOUVET, VALENCE (FR)

(21) Appl. No.: 19/343,575

(22) Filed: Sep. 29, 2025

(30) Foreign Application Priority Data
Oct. 1, 2024 (FR) FR2410545

(51) Int. Cl. G01S 1/04; G01S 1/02

(52) U.S. Cl. CPC G01S 1/045; G01S 1/024

(57) ABSTRACT

This invention relates to a method for determining radio navigation beacons for an aircraft. The method is implemented by an electronic determination device and comprises the following steps: selection of an N-tuple of beacon identifiers, N being greater than or equal to 2, from an estimated position of the aircraft; and provision of the selected N-tuple to an electronic calculation device, for calculating a new estimated position of the aircraft from the N beacons corresponding to the N identifiers of the selected N-tuple.1. During the selection step, the N-tuple is selected from a set of admissible N-tuples, obtained by means of the implementation of an artificial intelligence algorithm, the artificial intelligence algorithm receiving as input the estimated position of the aircraft and providing as output the set of admissible N-tuples.

### CROSS-REFERENCE TO RELATED APPLICATIONS

This application is a U.S. non-provisional application claiming the benefit of French Application No. 24 10545, filed on Oct. 1, 2024, which is incorporated herein by reference in its entirety.

### TECHNICAL FIELD

This invention relates to a method for determining radio navigation beacons for an aircraft. It also relates to a computer program, an electronic device for determining beacons, a navigation method, and an associated electronic navigation system.

It is in the field of secure aeronautical navigation.

### BACKGROUND

The International Civil Aviation Organization or ICAO, which participates in developing standards to standardize international air transport, has defined Performance Based Navigation or PBN.

PBN consists of determining, from sensors installed on the aircraft, a spatial position of the aircraft and using this position to guide the aircraft along an air route defined by waypoints.

The air routes that can be used in civil aviation are defined by the ICAO.

To ensure accuracy, this type of navigation requires the position of the aircraft to be calculated using an associated uncertainty estimate, also called EPU (Estimate of Position Uncertainty). The EPU is calculated assuming the absence of latent failure that could affect the measurements used for position calculation. A level of positioning accuracy performance can then be imposed, for example, 95% accuracy+/−10 Nm (nautical miles).

In Required Navigation Performance or RNP navigation, it is further recommended to implement an onboard monitoring and alert function to ensure a probabilistic protection radius around the calculated position with a low probability of exiting the given protection radius without an alarm, for example equal to 10.5/hour. This probability takes into account the hypothesis of the existence of latent failures affecting the measurements used for position calculation. The protection radius around a calculated position is called HIL (Horizontal Integrity Limit).

In summary, RNP navigation imposes two performance level indicators for positioning accuracy, namely a first indicator associated with the EPU, and a second indicator associated with the HIL.

As is known, RNP navigation is implemented using a Global Navigation Satellite System or GNSS. However, there are situations where satellite signals are weak or suffer from interference, intentional or not, which disrupts the position calculation. Additionally, there is also a risk that one of the onboard GNSS receivers may malfunction or fail.

To improve navigation safety, it is necessary to provide an alternative solution for calculating the position of the aircraft, which can be implemented in navigation according to an RNP procedure.

Before the development of GNSS systems, air navigation used radio beacons, placed on the ground and adapted to emit radio signals with a given range. In particular, there are radio beacons adapted to provide a distance measurement from the aircraft, also called DME (Distance Measuring Equipment) or DME beacons.

An aircraft equipped with radio sensors adapted to operate in the frequency band of radio beacons can obtain a distance estimate from a radio beacon when it is within the emission range of the beacon. To obtain an aircraft position meeting the first positioning accuracy performance indicator, it is necessary to use several radio beacons.

FR 3 088 443 A1 discloses a navigation method for an aircraft allowing the position of the aircraft from radio beacons to be determined using a current position of the aircraft and stored sets of beacons to meet the EPU and HIL criteria for RNP navigation during flight along a given route or area.

However, such a method only guarantees navigation performance along predefined routes. As soon as the aircraft leaves the predefined route, it is necessary to apply an alternative method to continue providing positioning. However, applying such a method over an area, for example around an airport, independent of a predefined route, requires a very large amount of data to be stored. Indeed, the geographical areas wherein, for any point, the distance measurements to a given subset of beacons make it possible to calculate a position with a protection radius below a desired value have irregular ovoid shapes of varying size, overlapping to a greater or lesser extent, which do not lend themselves well to rectangular meshing. The basic size of the rectangular mesh enabling coverage of a rectangular area encompassing an area around an airport is therefore very reduced, for example, a square of 1 NM. This implies, for example, a number of 14,400 elementary meshes to cover an area of 60 NM around an airport. If we assume that each mesh is represented by two geographic points coded on 32 bits, and considering, for example, that 5 identification elements of the DME beacons used per mesh are also coded on 32 bits, the size of the database necessary to code the airspace of 50 TMA is then 14,400,000 bytes.

### SUMMARY

The aim of the invention is therefore to propose a method for determining radio navigation beacons for an aircraft, compatible with implementation in an onboard navigation system, providing a set of beacons making it possible to calculate the position of the aircraft while respecting the RNP navigation performance criteria at any point in a useful area around an airport.

To this end, the invention relates to a method for determining radio navigation beacons for an aircraft, each radio navigation beacon being identified by a beacon identifier, the method being implemented by an electronic determination device and comprising the following steps:
selection of an N-tuple of beacon identifiers, N being greater than or equal to 2, from an estimated position of the aircraft; and
provision of the selected N-tuple to an electronic calculation device, for calculating a new estimated position of the aircraft from the N beacons corresponding to the N identifiers of the selected N-tuple;
such that during the selection step, the N-tuple is selected from a set of admissible N-tuples, obtained by means of the implementation of an artificial intelligence algorithm, the artificial intelligence algorithm receiving as input the estimated position of the aircraft and providing as output the set of admissible N-tuples.

By means of the invention, the new position of the aircraft can be calculated at any point in the space on which the artificial intelligence algorithm has been trained. Moreover, the position estimated by the method approaches the navigation performance of the training data of the artificial intelligence algorithm, which can be chosen to meet the accuracy and integrity criteria. Furthermore, the method only requires the artificial intelligence algorithm to be stored in the database.

Moreover, in the prior art, there is no analytical method to achieve the optimal selection that would allow the best localization performance to be obtained as soon as the radio beacons that can be selected are irregularly located around the current position. There is also no simple geometric criterion to select one set of beacons over another to guarantee a result that meets the desired performance level. The search for the best set of beacons is therefore highly combinatorial, resulting from a heuristic analysis through the possible combinations of a limited number of beacons corresponding to the maximum number of beacons to consider, among a possibly much larger number of available beacons. This search is generally incompatible with real-time processing by an onboard navigation system with limited computing power.

According to other advantageous aspects of the invention, the method for determining beacons comprises one or more of the following features, taken in isolation or in any technically possible combination:
the set of admissible N-tuples provided by the artificial intelligence algorithm is ordered according to a decreasing performance level, the first N-tuple of the ordered set of admissible N-tuples being the admissible N-tuple with the highest performance level, the performance level of an admissible N-tuple corresponding to a accuracy and/or integrity of the position calculation performed from said admissible N-tuple;
the set of admissible N-tuples provided by the artificial intelligence algorithm is ordered according to a decreasing covered area, the first N-tuple of the ordered set of admissible N-tuples being the admissible N-tuple with the largest covered area, the covered area of an admissible N-tuple being the area of a zone associated with said admissible N-tuple and allowing the calculation device to calculate the estimated position if the aircraft is in said zone;
the selected N-tuple is the first N-tuple of the ordered set of admissible N-tuples;
a previous N-tuple was retained during a previous iteration of the method, and the selected N-tuple is:
the previous N-tuple if the previous N-tuple belongs to the set of admissible N-tuples; or
the first N-tuple of the ordered set of admissible N-tuples otherwise;
the selection step comprises filtering the set of admissible N-tuples to eliminate admissible N-tuples including at least two beacon identifiers corresponding to beacons under maintenance, the filtering being preferably implemented if the first N-tuple of the ordered set of admissible N-tuples includes at least one beacon identifier corresponding to a beacon under maintenance;
the artificial intelligence algorithm has been previously trained during an initialization phase comprising:
a meshing of a predetermined geographical area;
for each mesh, a determination of beacons for which an aircraft located on said mesh can receive information, called accessible beacons;
for each mesh, a determination of a set of N-tuples of beacon identifiers, each beacon identifier of each N-tuple corresponding to one of the accessible beacons;
for each N-tuple of the set of N-tuples, a determination of the accuracy and/or integrity performance of the position calculation performed from said N-tuple;
a selection of a restricted set of N-tuples, comprising the N-tuples whose accuracy and/or integrity performance of the position calculation meet a required performance;
a training of the artificial intelligence algorithm from the restricted set of N-tuples;
the initialization phase further comprises:
a removal of redundancy (ies) in the restricted set of N-tuples before training the artificial intelligence algorithm, consisting of removing from the set of N-tuples one or more N-tuples covering an area already covered by at least one other N-tuple, the covered area of an N-tuple being the area of a zone associated with said N-tuple and allowing the calculation device to calculate the estimated position if the aircraft is in said zone;
the artificial intelligence algorithm comprises several artificial intelligence models, and the method comprises a preliminary step of selecting one of the artificial intelligence models based on the current estimated position, each artificial intelligence model being associated with a respective predetermined geographical area.

The invention also relates to a computer program including software instructions which, when executed by a computer, implement a determination method as defined above.

The invention also relates to a navigation method for an aircraft, comprising:
a determination of N radio navigation beacons by means of a determination method as described above and from an estimated position of the aircraft, the N determined radio navigation beacons corresponding to the selected N-tuple of identifiers;
a step of obtaining a distance measurement from each of the N determined beacons;
a step of calculating a new estimated position of the aircraft from the obtained distance measurements; and
a step of using the new estimated position of the aircraft as the current position of the aircraft.

The invention also relates to an electronic device for determining radio navigation beacons for an aircraft, configured to be onboard the aircraft, each radio navigation beacon being identified by a beacon identifier, the device comprising:
a beacon selection module, configured to select an N-tuple of beacon identifiers, N being greater than or equal to 2, from an estimated position of the aircraft, the N-tuple being selected from a set of admissible N-tuples, obtained by means of the implementation of an artificial intelligence algorithm, the artificial intelligence algorithm receiving as input the estimated position of the aircraft and providing as output the set of admissible N-tuples; and
a provision module, configured to provide the selected N-tuple to an electronic calculation device, for calculating a new estimated position of the aircraft from the N beacons corresponding to the N identifiers of the selected N-tuple.

The invention finally relates to an electronic navigation system for an aircraft, configured to be onboard the aircraft, comprising:
an electronic determination device as described above, providing an N-tuple of beacon identifiers; and
an electronic calculation device, comprising:
an obtaining module, configured to obtain a distance measurement from each of the N beacons corresponding to the selected N-tuple of identifiers by the determination device;
a calculation module, configured to calculate a new estimated position of the aircraft from the obtained distance measurements; and
a usage module, configured to use the new estimated position of the aircraft as the current position of the aircraft.

### BRIEF DESCRIPTION OF THE DRAWINGS

The invention will become clearer upon reading the following description, given solely by way of non-limiting example, and made with reference to the drawings wherein:

FIG. 1 is a diagram of an aircraft comprising an electronic navigation system according to the invention;

FIG. 2 is a diagram illustrating the estimation of a position of the aircraft shown in FIG. 1 from radio navigation beacons;

FIG. 3 is a flowchart of an initialization phase prior to the method for determining radio navigation beacons according to the invention; and

FIG. 4 is a flowchart of a method for determining radio navigation beacons according to the invention.

### DETAILED DESCRIPTION

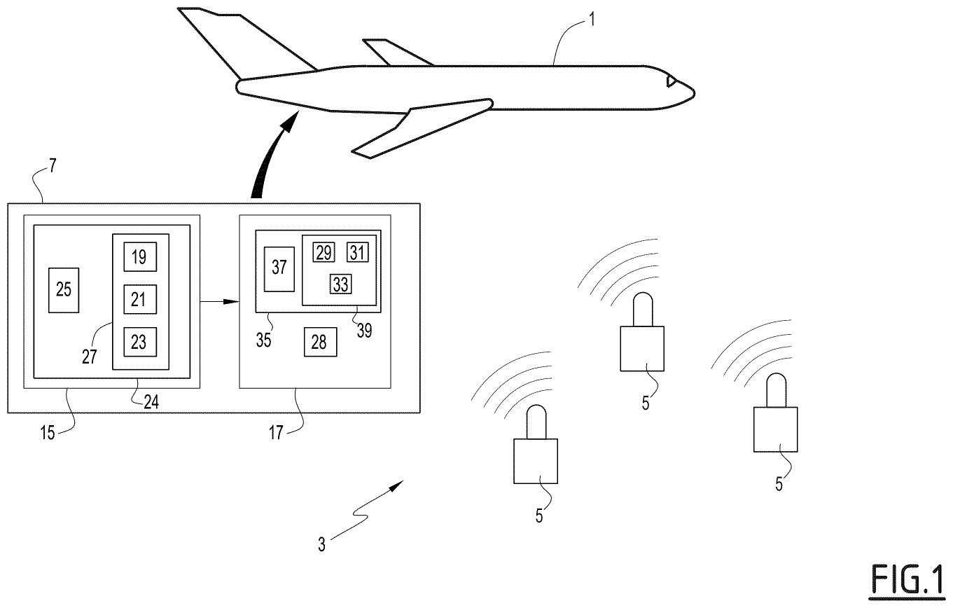

In FIG. 1, an aircraft 1 flies over an area of interest 3 equipped with radio navigation beacons 5. The area of interest 3 is, for example, a terminal maneuvering area of an airport, or a square centered on an airport. The radio navigation beacons 5 are placed on the ground and capable of emitting radio signals with a given emission range. The radio navigation beacons 5 are particularly DME equipment and are adapted to provide a distance measurement from the aircraft 1. Each radio navigation beacon 5 is identified by a respective beacon identifier.

The aircraft 1 is equipped with an electronic navigation system 7. The role of the navigation system 7 is to calculate a current position of the aircraft, which is an estimated position from a set of beacons 5. To do this, the electronic navigation system 7 simultaneously performs measurements on signals emitted by several beacons 5 whose position is known to the electronic navigation system 7, and calculates the current position of the aircraft by a multilateration technique.

Required Navigation Performance, or RNP navigation, defined by the ICAO, must meet two performance indicators: accuracy and integrity.

Accuracy is quantified by an uncertainty estimate associated with the calculation of the position of the aircraft 1, called EPU. The EPU is calculated assuming the absence of latent failure that could affect the measurements used for position calculation. A level of positioning accuracy performance can then be imposed, for example, 95% accuracy+/−10 Nm (nautical miles).

Integrity is quantified by a probabilistic protection radius around the calculated position with a probability of exiting the protection radius given, for example, equal to 10⁻⁵/hour. This probability takes into account the hypothesis of the existence of latent failures affecting the measurements used for position calculation. The protection radius around a calculated position is called HIL.

Thus, the role of the electronic navigation system 7 is to perform an estimation of the current position of the aircraft 1 while respecting the accuracy and integrity criteria.

Physically, the electronic navigation system 7 can only take into account signals emitted by a limited number of beacons 5. A determination of the set of beacons 5 to consider must therefore be made prior to the position calculation by multilateration. The accuracy of the estimated current position calculated in this way is related to the relative position of the beacons 5 to the aircraft 1, and the accuracy of the distance measurement itself.

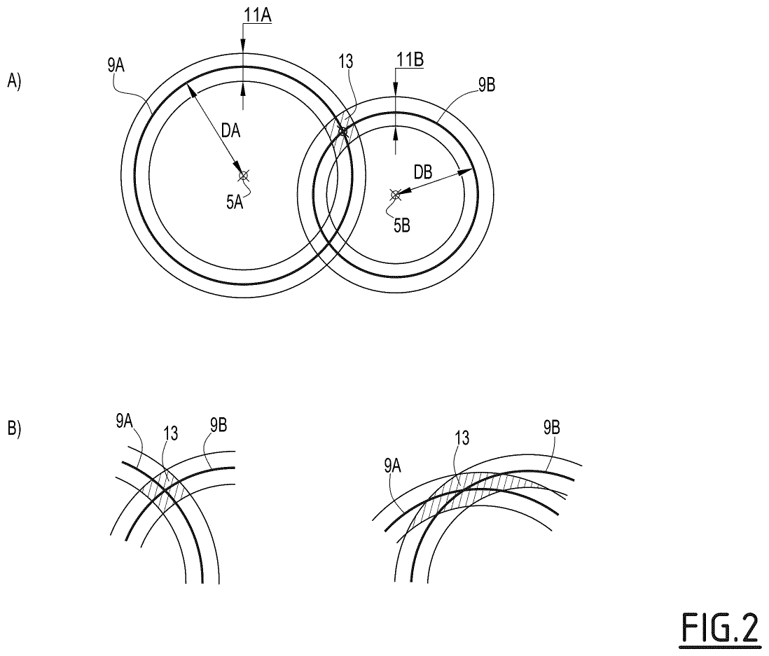

FIG. 2 illustrates the estimation of a position of the aircraft 1 from two beacons 5.

In insert A of FIG. 2, the first circle 9A represents the possible positions of the aircraft 1 knowing the exact distance DA separating the aircraft 1 from a first beacon 5A. Due to measurement uncertainties on the distance DA, the first ring 11A located around the first circle 9A represents the possible positions of the aircraft 1 knowing the distance DA within uncertainties. Similarly, the second circle 9B represents the possible positions of the aircraft 1 knowing the exact distance DB separating the aircraft 1 from a second beacon 5B, and the second ring 11B represents the possible positions of the aircraft 1 knowing the distance DB within uncertainties.

The position of the aircraft 1 is at the intersection of circles 9A and 9B. Taking into account the measurement uncertainties of distances, the current position of the aircraft 1 can be estimated at the intersection of rings 11A and 11B, this intersection forming an uncertainty zone 13, represented in FIG. 2.

Insert B of FIG. 2 shows the uncertainty zones 13 in two different situations corresponding to two different positions of beacons 5A and 5B.

It is then understood that the uncertainty zone 13 will be larger, i.e., the estimated position will be less accurate the more the triangle formed by the position of the aircraft and the two positions of beacons 5A and 5B is flattened, or the lower the accuracy of the distance measurements. However, it turns out that in many cases, the number of beacons 5 considered for position calculation is less, or even much less, than the number of beacons 5 that could be used. The determination of the set of beacons 5 to consider is therefore an important aspect when one wants to optimize the positioning performance of the navigation system 7.

Thus, the electronic navigation system 7 represented in FIG. 1 comprises an electronic determination device for radio navigation beacons 15 and an electronic calculation device 17.

The electronic determination device 15 comprises a beacon selection module 19 and a provision module 21. Optionally, the electronic determination device 15 comprises a model selection module 23.

The beacon selection module 19 is configured to select an N-tuple of beacon identifiers, N being greater than or equal to 2, from an estimated position of the aircraft. The N-tuple is selected from a set of admissible N-tuples, obtained by means of the implementation of an artificial intelligence algorithm, the artificial intelligence algorithm receiving as input the estimated position of the aircraft 1 and providing as output the set of admissible N-tuples.

Advantageously, the artificial intelligence algorithm comprises one or more artificial intelligence models, each artificial intelligence model being associated with a respective area of interest 3.

Each artificial intelligence model is advantageously a neural network whose structure is defined below.

Each neural network includes an ordered succession of layers of neurons, each taking its inputs from the outputs of the previous layer.

More specifically, each layer comprises neurons taking their inputs from the outputs of the neurons of the previous layer, or from the input variables for the first layer.

Alternatively, more complex neural network structures can be considered with a layer that can be connected to a layer further away than the immediately previous layer.

Each neuron is also associated with an operation, i.e., a type of processing, to be performed by said neuron within the corresponding processing layer.

Each layer is connected to the other layers by a plurality of synapses. A synaptic weight is associated with each synapse, and each synapse forms a connection between two neurons. It is often a real number, which can take positive or negative values. In some cases, the synaptic weight is a complex number.

Each neuron is capable of performing a weighted sum of the value(s) received from the neurons of the previous layer, each value being then multiplied by the respective synaptic weight of each synapse, or connection, between said neuron and the neurons of the previous layer, then applying an activation function, typically a non-linear function, to said weighted sum, and delivering at the output of said neuron, in particular to the neurons of the next layer to which it is connected, the value resulting from the application of the activation function. The activation function allows a non-linearity to be introduced in the processing performed by each neuron. The sigmoid function, the hyperbolic tangent function, and the Heaviside function are examples of activation functions.

Optionally, each neuron is also capable of adding a bias to the weighted sum, and the value delivered at the output of said neuron is then the value resulting from the activation function, said function being then applied to the addition of the weighted sum and the bias.

A fully connected layer of neurons is a layer wherein the neurons of said layer are each connected to all the neurons of the previous layer. Such a type of layer is more often referred to by the term “fully connected,” and sometimes referred to as a “dense layer.”

In particular, each neural network of the considered artificial intelligence algorithm comprises an input layer, at least one hidden layer, and an output layer.

The input layer comprises, for example, two nodes, receiving respectively the latitude and longitude of the current position of the aircraft 1, and typically normalizing these inputs between −1 and 1 from lower and upper bounds of the area of interest 3. Alternatively, the input layer normalizes the inputs by calculating the deviation from the center of the area of interest 3, divided by the variance of the deviations from the center of the area of interest 3.

The at least one hidden layer comprises N nodes and a first activation function. The first activation function is, for example, a sigmoid function of the form

$${f}^{[ 1 ]} ( x ) = \frac{2}{1 + {e}^{- 2 x}} - 1 ,$$

where e denotes the exponential function. Alternatively, the first activation function is of the ReLU type f^{[1]}(x)=max(0,x) or even Leaky ReLU

$${f}^{[ 1 ]} ( x ) = \{ \begin{matrix}x si x \geq 0 \\ α x si x < 0\end{matrix} ;$$

with, for example, α=0.01.

The output layer comprises M nodes and a second activation function. The second activation function is, for example, the normalized exponential function.

Thus, taking the example of a single hidden layer, the nodes of the hidden layer calculate the values h_{j∈[1:N]} from the normalized inputs x_{i∈[1:2]}:

$${h}_{j} = {f}^{[ 1 ]} ( {w}_{j , i}^{[ 1 ]} \times {x}_{i} + {b}_{j}^{[ 1 ]} )$$

where w_{j,i} represent the associated synaptic weights, and
bⱼ represent the associated biases.

And the M nodes of the output layer calculate the value z_{k∈[1:M]} from the values h_{j∈[1:N]}:

$${y}_{k} = {w}_{k , j}^{[ 2 ]} \times {h}_{j} + {b}_{k}^{[ 2 ]}$$

where w_{k,j} represent the associated synaptic weights, and
bₖ represent the associated biases.

$${z}_{k} = {f}^{[ 2 ]} ( y , k ) = \frac{{e}^{{y}_{k} - \begin{matrix}max \\ k ∈ [ 1 : M ]\end{matrix} ( {y}_{k} )}}{{\sum }_{k = 1}^{M} {e}^{{y}_{k} - max ( {y}_{k} )}} .$$

The neural network associates, with a mesh, a vector of M elements, corresponding to each of the considered N-tuples.

The covered area of an N-tuple is defined as the area of a zone associated with said N-tuple and allowing the calculation device 17 to calculate the estimated position if the aircraft 1 is in said zone. The performance level of an admissible N-tuple is defined as the accuracy and/or integrity, as previously defined, of the position calculation performed from said admissible N-tuple.

The M elements vary, for example, between 0 and 1, the value 0 being reached when the covered area of the N-tuple covers no point of the considered mesh, and the value 1 being reached when the covered area of the N-tuple fully covers the considered mesh.

Other scoring methods are possible by associating an intermediate score to N-tuples of intermediate covered area or performance level, or scored according to their distance to the N-tuple with the largest covered area or the highest performance level, which will have the maximum score of 1.

The set of admissible N-tuples is then the set of N-tuples whose predicted value is greater than a predetermined threshold between 0 and 1. In other words, the set of admissible N-tuples is then the set of N-tuples whose predicted value representative of the covered area or performance level is greater than said predetermined threshold.

The set of admissible N-tuples is advantageously ordered according to an ordering criterion. The first N-tuple is then called the N-tuple ranked first within the ordered set of admissible N-tuples. In other words, the first N-tuple is the N-tuple of the set of admissible N-tuples that maximizes the ordering criterion.

According to a first embodiment of the invention, the ordering criterion is the performance level. In other words, the set of admissible N-tuples is ordered according to a decreasing performance level, the first N-tuple of the ordered set of admissible N-tuples being then the admissible N-tuple with the highest performance level.

According to a second embodiment of the invention, the ordering criterion is the covered area. In other words, the set of admissible N-tuples provided by the artificial intelligence algorithm is ordered according to a decreasing covered area. Thus, the first N-tuple of the ordered set of admissible N-tuples is the admissible N-tuple with the largest covered area.

The beacon selection module 19 is then configured to select an N-tuple of beacon identifiers among the admissible N-tuples, according to rules that are explained below.

The provision module 21 is configured to provide the selected N-tuple to the electronic calculation device 17, for calculating a new estimated position of the aircraft 1 from the N beacons corresponding to the N identifiers of the selected N-tuple. The provision module 21 comprises for this purpose a means of digital transmission, wired or wireless, to the electronic calculation device 17.

The model selection module 23 is advantageous in the case where the artificial intelligence algorithm comprises several artificial intelligence models. The role of the model selection module 23 is then to select the artificial intelligence model to be used by the beacon selection module 19, among the different artificial intelligence models of the artificial intelligence algorithm, based on the current estimated position.

In the example shown in FIG. 1, the electronic determination device 15 comprises an information processing unit 24 formed, for example, of a processor 25 and a memory 27 associated with the processor 25.

In the example shown in FIG. 1, the beacon selection module 19 and the provision module 21, as well as optionally the model selection module 23, are each implemented in the form of software, or a software module, executable by the processor 25. The memory 27 of the electronic determination device 15 is then capable of storing beacon selection software and provision software, as well as optionally model selection software. The processor is then capable of executing each of the software among the beacon selection software and the provision software, as well as optionally the model selection software.

In an unrepresented variant, the beacon selection module 19 and the provision module 21, as well as optionally the model selection module 23, are each implemented in the form of a programmable logic component, such as an FPGA (Field Programmable Gate Array), or an integrated circuit, such as an ASIC (Application Specific Integrated Circuit).

When the electronic determination device 15 is implemented in the form of one or more software, i.e., in the form of a computer program, also called a computer program product, it is also capable of being recorded on a medium, not represented, that can be read by a computer. The computer-readable medium is, for example, a medium capable of storing electronic instructions and being connected to a bus of a computer system. For example, the readable medium is an optical disk, a magneto-optical disk, a ROM memory, a RAM memory, any type of non-volatile memory (for example, FLASH or NVRAM), or a magnetic card. A computer program comprising software instructions is then stored on the readable medium.

The electronic calculation device 17 comprises a receiver 28 as well as an obtaining module 29, a calculation module 31, and a usage module 33.

The receiver 28 is a radio frequency signal receiver, which generally performs propagation delay measurements between a beacon 5 and the aircraft 1 from signals superimposed on a carrier signal defined in a given frequency band. It converts the propagation delay measurements into distances and can then use a subset of these measurements whose emission origin position is known to calculate the reception position using a multilateration algorithm.

To perform a measurement, for example, a distance measurement from a beacon 5, the receiver 28 tunes the reception frequency to the frequency of the carrier signal of the selected beacon, performs the measurements on the signal superimposed on the carrier signal, and tracks these signals during the time these measurements can be made and used.

The superimposed signal can be, for example, the replica of a limited duration pulse sequence superimposed on a carrier signal, re-emitted with a fixed delay, and on a frequency shifted by a beacon 5, in response to the interrogation of this beacon 5 by the electronic navigation system 7. The distance information is then deduced by the electronic navigation system 7 from the time delay observed between the emission and reception of the pulse sequence.

The principle of discrimination between signals emitted by different beacons 5 is based on the frequency separation of the carrier signals.

The obtaining module 29 is configured to obtain, using the receiver 28, a distance measurement from each of the N beacons corresponding to the N-tuple of identifiers selected by the radio navigation beacon selection device.

The calculation module 31 is configured to calculate a new estimated position of the aircraft from the obtained distance measurements.

The usage module 33 is configured to use the new estimated position of the aircraft as the current position of the aircraft 1. The current position of the aircraft 1 is the estimated position used by the aircraft 1.

The structure of the electronic calculation device 17 is similar to the structure of the electronic determination device 15. Thus, in the example shown in FIG. 1, the electronic calculation device 17 comprises an information processing unit 35 formed, for example, of a processor 37 and a memory 39 associated with the processor 37.

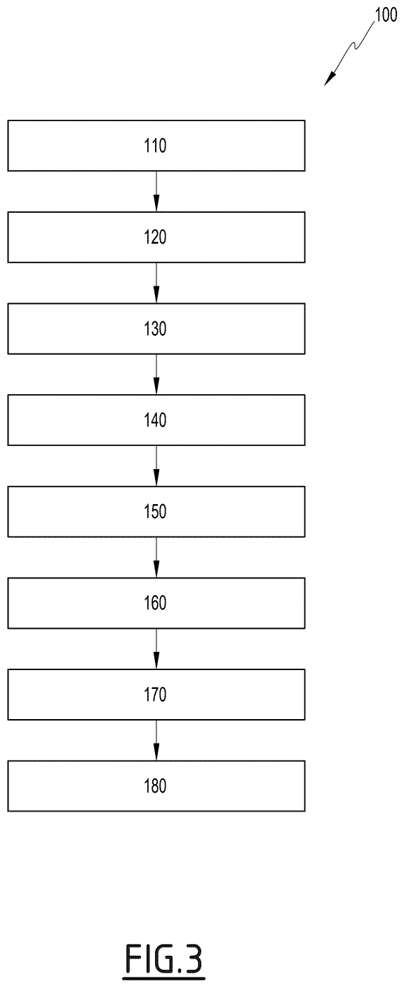

Prior to using the electronic navigation system 7, the artificial intelligence algorithm is trained during an initialization phase 100, represented in FIG. 3.

The initialization phase 100 comprises a meshing 110, a determination of accessible beacons 120, a determination of a set of N-tuples 130, a determination of performances 140, a selection of a restricted set of N-tuples 150, a removal of redundancies 160, a training 170, and a verification 180.

During the meshing 110, the set of points located at the intersection of a regular mesh of the area of interest 3 with a square mesh measuring, for example, 1 nautical mile on each side is determined.

During the determination of accessible beacons 120, it is determined, for each mesh of the meshing, a set of beacons 5 for which the aircraft 1 located on said mesh can receive information. These beacons 5 are called accessible beacons. In other words, the accessible beacons in a mesh are the beacons 5 for which the receiver 28 located on said mesh is capable of receiving the signals emitted by said accessible beacons. For a given mesh, the accessible beacons are determined from a global database of beacons, comprising a position and characteristics of each beacon 5, as well as accessibility criteria defined by aeronautical standards.

For the determination of accessible beacons 120, it is necessary to consider a signal reception altitude relative to the ground. The altitude retained for a mesh will depend on the expected operation in the region of interest. For example, in the case of a terminal maneuvering area, this altitude will depend on the distance of the mesh from the destination airport. The function will model a typical minimum descent profile towards the airport: for example, a fixed height of 1,500 feet up to 5 nautical miles from the airport, then a height determined by a 3° slope along radials from the airport to the meshes of the terminal maneuvering area located at 10 nautical miles, then a constant altitude of about 3,000 feet for the meshes located between 10 nautical miles and 20 nautical miles around the airport, then an increasing height along a 2.5° slope when moving away along radials to the airport until reaching a height of 6,000 feet above the airport, then a constant height. The altitude retained for the different meshes will be the altitude of the airport to which the height from the descent profile will be added. In the case where the airport is located in rugged areas, the altitude retained for the different meshes is the altitude of the airport to which the height from the descent profile is added on the one hand, and a height of the relief around the airport on the other hand. Furthermore, for the determination of accessible beacons in the case of rugged areas, terrain masks can be used to account for signal masking by the relief around the airport.

During the determination of the set of N-tuples 130, a set of N-tuples of beacon identifiers is determined for each mesh, each beacon identifier of each N-tuple corresponding to one of the accessible beacons. The set of N-tuples determined for a mesh does not necessarily comprise all possible combinations of accessible beacons for said mesh. For example, the set of accessible beacon sets can be reduced by eliminating accessible beacons located at a distance less than a given threshold from another accessible beacon with better coverage characteristics. The given threshold is, for example, 3 nautical miles.

During the determination of performances 140, for each N-tuple of the set of N-tuples, accuracy and/or integrity performances of the position calculation performed from said N-tuple are determined. Advantageously, to avoid excessive calculation, the performance calculation is stopped as soon as a predetermined number of solutions satisfying an optimal performance criterion, for example, significantly lower than the desired RNP performance, is found. For example, the predetermined number is 10, and the optimal performance criterion corresponds to a predicted protection radius less than 1.25 nautical miles for an RNP criterion imposing a protection radius less than 2 nautical miles.

The determination of performances is initially carried out in a given mesh of the meshing, for example, at the airport. The determination of performances is then continued on adjacent meshes, step by step, testing in priority the N-tuples that have given satisfaction on previous meshes. When the number of solutions becomes insufficient with the N-tuples already identified for previous meshes, other N-tuples are considered.

During the selection of a restricted set of N-tuples 150, an inventory of all N-tuples that have satisfied the performance conditions as determined previously is made. Then, each N-tuple is associated with the meshed surface by the meshes for which the N-tuple has been recognized as a solution satisfying the desired performance constraints. Each mesh of the region of interest 3 is part of one or more of these meshed surfaces. Thus, for each mesh, there is a more or less strong redundancy level of coverage.

The removal of redundancies 160 aims to reduce as much as possible the redundancy level of coverage of the different meshes, to keep only the minimum number of surfaces that ensure, however, almost all the coverage of the region of interest 3. To do this, the surfaces associated with the N-tuples are sorted, for example, in decreasing order of size. We start by considering the meshes covered by the largest surface. Then we search among the remaining surfaces, the one that covers the maximum number of meshes not yet covered by the first surface. This process is repeated by searching in the remaining surfaces for the one that covers the maximum number of meshes not already covered, and the process is stopped as soon as almost all the meshes of the area of interest 3, for example, 98%, are covered by a surface. Indeed, not all meshes need to be considered, since the optimal performance criterion considered to constitute the N-tuples is more demanding than the RNP performance criterion considered for RNP navigation in the region of interest 3. Outside a meshed surface, but in an area close to the border of this surface, the achievable performances by localization using the N-tuple associated with the surface are generally compatible with RNP constraints. At the end of this phase, we have therefore obtained for almost all the meshes of the region of interest 3 associations between these meshes and one or more N-tuples for which we have the guarantee that their use allows RNP navigation, and this applies in an area around this mesh of variable size. Thus, it will be considered that at the end of the removal of redundancy 160, the final number of N-tuples associated with the surfaces retained to cover the area of interest 3 can be all or part of the initial number of identified N-tuples.

The training 170 consists of training the previously defined artificial intelligence algorithm, i.e., in particular, to define the values of synaptic weights and biases. To do this, we initially consider a number of nodes in the internal layer equal to half the number M of N-tuples retained for the region of interest.

The training data is formed by associating with each mesh a vector of M elements varying between 0 and 1, according to the configuration retained of the artificial intelligence model. The artificial intelligence model is trained on this training data until convergence criteria associated with the training method indicate that the training process has converged, and the network parameters have been identified.

During the verification 180, the convergence performances of the artificial intelligence algorithm are confirmed by verifying a posteriori that the outputs of the algorithm for the meshes are indeed the N-tuples that were provided during training. To do this, it is considered that the network predicts, for a given mesh, the first N-tuple of the ordered set of admissible N-tuples. The success rate of the network is then calculated. If this success rate is greater than a given value, for example, 95%, it is considered that the convergence of the network is satisfactory. If necessary, the size of the hidden layer(s) is increased by gradually increasing the number of nodes until a maximum number of M nodes is reached. These verification data correspond to the complete meshing of the area of interest 3 taking into account all possible longitude and latitude values entering the neural network. In this way, a perfectly predictable behavior of the neural network is guaranteed, as it will have been verified for all possible requests. The longitude and latitude values are, for example, rounded to the nearest 1/10th of a degree to query the artificial intelligence algorithm.

The initialization phase is advantageously executed at each evolution of the global beacon database. In other words, the artificial intelligence algorithm is regenerated at each evolution of the global beacon database, to take these changes into account.

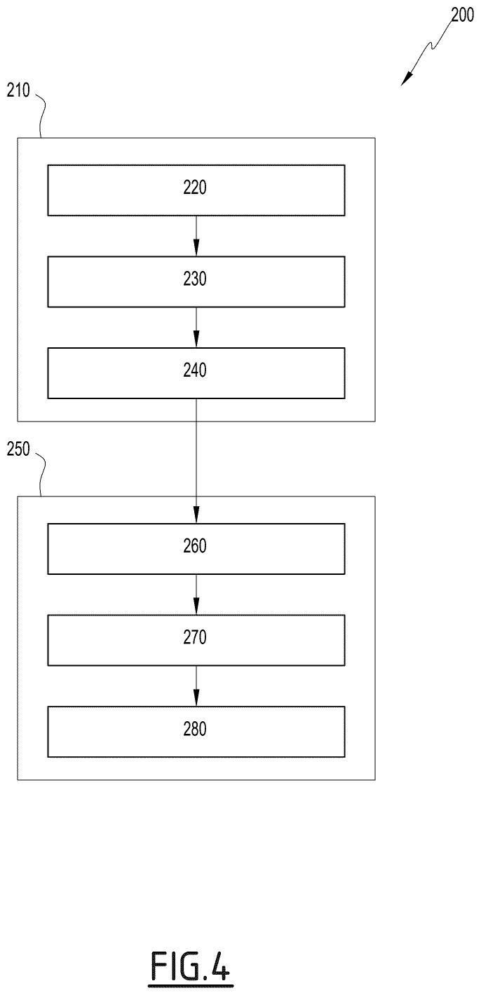

Once the initialization phase is completed, the electronic navigation system 7 is ready to be used. A navigation method 200, implemented by the electronic navigation system 7, is represented in FIG. 4 and described below.

The navigation method 200 comprises, initially, a determination of N radio navigation beacons by means of a beacon determination method 210. It also comprises, in a second step, an update of the position 250.

The value of N is fixed prior to the method. For the position estimation to be possible, N must necessarily be greater than or equal to 2. Advantageously, the value of N is greater than or equal to 3, to calculate a protection radius, guaranteeing, for example, an integrity risk less than 105/hour. Advantageously again, the value of N is greater than or equal to 4, to introduce redundancies to compensate for measurement uncertainties. In the preferred embodiment of the invention, the value of N is equal to 5.

The beacon determination method 210 is implemented by the electronic determination device 15 and comprises a beacon selection step 230 and a provision step 240. Advantageously, the beacon determination method 210 also comprises a model selection step 220, prior to the beacon selection step 230.

The model selection step 220 is implemented by the model selection module 23 and consists of selecting the artificial intelligence model used by the beacon selection module among the different artificial intelligence models of the artificial intelligence algorithm. In particular, the selected artificial intelligence model is the artificial intelligence model associated with the area of interest 3 to which the current position of the aircraft 1 belongs.

The beacon selection step 230 is implemented by the beacon selection module 19 and consists of selecting an N-tuple among the admissible N-tuples.

The selected N-tuple is advantageously the first N-tuple of the ordered set of admissible N-tuples.

Alternatively, the set of admissible N-tuples is compared to a previous N-tuple, retained during a previous iteration of the navigation method 200. If the previous N-tuple belongs to the set of admissible N-tuples, then the selected N-tuple is the previous N-tuple. Otherwise, the selected N-tuple is the first N-tuple of the ordered set of admissible N-tuples.

The beacon selection step 230 advantageously comprises filtering the set of admissible N-tuples to eliminate admissible N-tuples including at least two beacon identifiers corresponding to beacons under maintenance. The filtering is preferably implemented if the first N-tuple of the ordered set of admissible N-tuples includes at least one beacon identifier corresponding to a beacon under maintenance.

The provision step 240 is implemented by the selection module 21. It is during this step that the selected N-tuple is provided by the provision module 240 to the electronic calculation device 17.

The position update 250 is implemented by the calculation device 17 and comprises an obtaining step 260, a calculation step 270, and a usage step 280.

The obtaining step 260 is implemented by the obtaining module 29 and consists of obtaining, using the receiver 28, a distance measurement of the aircraft 1 from each of the determined N beacons.

The calculation step 270 is implemented by the calculation module 31 and consists of calculating a new estimated position of the aircraft 1 from the obtained distance measurements. This step involves a multilateration technique known to those skilled in the art.

The usage step 280 is implemented by the usage module 33 and consists of using the new estimated position of the aircraft as the current position of the aircraft 1.

At the end of the usage step 280, the current position of the aircraft 1 has been updated by a new estimate thanks to the radio beacons 5. The navigation method 200 can then be executed again as needed to update the current position of the moving aircraft 1. For example, the navigation method 200 is executed iteratively, at a predetermined frequency. Alternatively, the navigation method 200 can be triggered by equipment onboard the aircraft or by a command from a pilot of the aircraft 1. It is then understood that the performance of the navigation method 200 described below depends both on the value of N and on the refresh frequency of the current position by a new iteration of the method.

Any feature described above for an example or a variant can also be implemented in the other examples and variants described above, as long as technically possible.

1. A method for determining radio navigation beacons for an aircraft, each radio navigation beacon being identified by a beacon identifier, the method being implemented by an electronic determination device and comprising the following steps:
selection of an N-tuple of beacon identifiers, N being greater than or equal to 2, from an estimated position of the aircraft; and
provision of the selected N-tuple to an electronic calculation device, for calculating a new estimated position of the aircraft from the N beacons corresponding to the N identifiers of the selected N-tuple;
wherein, during the selection step, the N-tuple is selected from a set of admissible N-tuples, obtained by means of the implementation of an artificial intelligence algorithm, the artificial intelligence algorithm receiving as input the estimated position of the aircraft and providing as output the set of admissible N-tuples.

2. The method according to claim 1, wherein the set of admissible N-tuples provided by the artificial intelligence algorithm is ordered according to a decreasing performance level, the first N-tuple of the ordered set of admissible N-tuples being the admissible N-tuple with the highest performance level, the performance level of an admissible N-tuple corresponding to an accuracy and/or integrity of the position calculation performed from said admissible N-tuple.

3. The method according to claim 1, wherein the set of admissible N-tuples provided by the artificial intelligence algorithm is ordered according to a decreasing covered area, the first N-tuple of the ordered set of admissible N-tuples being the admissible N-tuple with the largest covered area, the covered area of an admissible N-tuple being the area of a zone associated with said admissible N-tuple and allowing the calculation device to calculate the estimated position if the aircraft is in said zone.

4. The method according to claim 2, wherein the selected N-tuple is the first N-tuple of the ordered set of admissible N-tuples.

5. The method according to claim 2, wherein a previous N-tuple was retained during a previous iteration of the method, and wherein the selected N-tuple is:
the previous N-tuple if the previous N-tuple belongs to the set of admissible N-tuples; or
the first N-tuple of the ordered set of admissible N-tuples otherwise.

6. The method according to any of claim 2, wherein the selection step comprises filtering the set of admissible N-tuples to eliminate admissible N-tuples including at least two beacon identifiers corresponding to beacons under maintenance,
the filtering being preferably implemented if the first N-tuple of the ordered set of admissible N-tuples includes at least one beacon identifier corresponding to a beacon under maintenance.

7. The method according to claim 1, wherein the artificial intelligence algorithm has been previously trained during an initialization phase comprising:
a meshing of a predetermined geographical area;
for each mesh, a determination of beacons for which an aircraft located on said mesh can receive information, called accessible beacons;
for each mesh, a determination of a set of N-tuples of beacon identifiers, each beacon identifier of each N-tuple corresponding to one of the accessible beacons;
for each N-tuple of the set of N-tuples, a determination of performance of accuracy and/or integrity of the position calculation performed from said N-tuple;
a selection of a restricted set of N-tuples, comprising the N-tuples whose accuracy and/or integrity performance of the position calculation meet a required performance; and
a training of the artificial intelligence algorithm from the restricted set of N-tuples.

8. The method according to claim 1, wherein the initialization phase further comprises:
a removal of redundancy(ies) in the restricted set of N-tuples before training the artificial intelligence algorithm, consisting of removing from the set of N-tuples one or more N-tuples covering an area already covered by at least one other N-tuple, the covered area of an N-tuple being the area of a zone associated with said N-tuple and allowing the calculation device to calculate the estimated position if the aircraft is in said zone.

9. The method according to claim 7, wherein the artificial intelligence algorithm comprises several artificial intelligence models, and the method comprises a preliminary step of selecting one of the artificial intelligence models based on the current estimated position, each artificial intelligence model being associated with a respective predetermined geographical area.

10. A computer program including software instructions which, when executed by a computer, implement a method according to claim 1.

11. A navigation method for an aircraft, comprising:
a determination of N radio navigation beacons by means of a determination method according to claim 1 and from an estimated position of the aircraft, the N determined radio navigation beacons corresponding to the selected N-tuple of identifiers;
a step of obtaining a distance measurement from each of the N determined beacons;
a step of calculating a new estimated position of the aircraft from the obtained distance measurements; and
a step of using the new estimated position of the aircraft as the current position of the aircraft.

12. An electronic determination device for radio navigation beacons for an aircraft, configured to be onboard the aircraft, each radio navigation beacon being identified by a beacon identifier, the device comprising:
a beacon selection module, configured to select an N-tuple of beacon identifiers, N being greater than or equal to 2, from an estimated position of the aircraft, the N-tuple being selected from a set of admissible N-tuples, obtained by means of the implementation of an artificial intelligence algorithm, the artificial intelligence algorithm receiving as input the estimated position of the aircraft and providing as output the set of admissible N-tuples; and
a provision module, configured to provide the selected N-tuple to an electronic calculation device, for calculating a new estimated position of the aircraft from the N beacons corresponding to the N identifiers of the selected N-tuple.

13. An electronic navigation system for an aircraft, configured to be onboard the aircraft, comprising:
an electronic determination device according to claim 12, providing an N-tuple of beacon identifiers; and
an electronic calculation device, comprising:
an obtaining module, configured to obtain a distance measurement from each of the N beacons corresponding to the selected N-tuple of identifiers by the determination device;
a calculation module, configured to calculate a new estimated position of the aircraft from the obtained distance measurements; and
a usage module, configured to use the new estimated position of the aircraft as the current position of the aircraft.
